(19) United States
(12) Patent Application Publication
(10) Pub. No.: US 2024/0329943 A1
(43) Pub. Date: Oct. 3, 2024

(54) SOURCE CODE SYNTHESIS FOR DOMAIN SPECIFIC LANGUAGES FROM NATURAL LANGUAGE TEXT

(71) Applicant: Siemens Aktiengesellschaft, Munich (DE)

(72) Inventors: Tushar Sharma, Charlotte, NC (US); Anant Kumar Mishra, Charlotte, NC (US)

(73) Assignee: Siemens Aktiengesellschaft, Munich (DE)

(21) Appl. No.: 18/577,471

(22) PCT Filed: Aug. 6, 2021
(86) PCT No.: PCT/US2021/044875

§ 371 Date: Jan. 8, 2024

(51) Int. Cl. G06F 8/35; G06N 3/08

(52) U.S. Cl. CPC G06F 8/35; G06N 3/08

(57) ABSTRACT

A computing system that includes a neural network can receive a statement written in natural language text. The neural network can determine an operation intended by the statement. Based on the operation, the computing system can determine one or more parameters that correspond to the operation. Based on the operation, the computing system can identify a template in a target domain-specific language. Further, the computing system can populate the template with the operation and the one or more parameters. so as to automatically generate source code in the target domain-specific language, from the statement written in natural language text.

### BACKGROUND

Programming is a non-trivial business activity that often involves not only domain specific problem-solving skills, but also critical thinking and considerations toward various aspects of quality of the produced code. The software engineering community has produced some tools to increase the productivity of software developers, and also to facilitate various programming tasks in order to make those tasks easier. Program synthesis is one such method that can be implemented to produce source code snippets given simpler inputs. It is recognized herein, however, that current program techniques lack technical capabilities related to processing particular inputs.

### BRIEF SUMMARY

Embodiments of the invention address and overcome one or more of the described-herein shortcomings or technical problems by providing methods, systems, and apparatuses for generating source code from natural language text. In particular, code snippets, regular expressions, and abstract syntax trees can be generated for various domains in various domain specific languages (DSLs), such as programmable logic controller (PLC) languages, among others.

In an example aspect, a computing system that includes a neural network can receive a statement written in natural language text. The neural network can determine an operation intended by the statement. Based on the operation, the computing system can determine one or more parameters that correspond to the operation. Based on the operation, the computing system can identify a template in a target domain-specific language. Further, the computing system can populate the template with the operation and the one or more parameters, so as to automatically generate source code in the target domain-specific language, from the statement written in natural language text.

### BRIEF DESCRIPTION OF THE SEVERAL VIEWS OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 shows an example neural machine translator (NMT) module in accordance with an example embodiment.

FIG. 2 is a block diagram of an example system that includes the NMT module configured to generate source code in domain-specific languages from natural language text, wherein the neural machine translator can include one or more neural networks and a code generator communicatively coupled to the one or more neural networks.

FIG. 3 shows an example neural network that can part of the system illustrated in FIG. 2, wherein the neural network can be trained to determine or predict operations associated with respective natural language text inputs.

FIG. 4 depicts an example template that can be populated so as to output source code based on natural language text.

FIG. 5 is a flow diagram that illustrates an example operation that can be performed by the computing system of FIG. 2, in accordance with an example embodiment.

FIG. 6 illustrates a computing environment within which embodiments of the disclosure may be implemented.

### DETAILED DESCRIPTION

As initial matter, it is recognized herein that automatically generating source code from a description provided in natural language text could significantly support developers and also enable non-programmers to work within certain programming environments. Current approaches to automatically generating source code generally rely on simpler inputs (e.g., code snippets, examples, idioms) as compared to natural language text. Other approaches that use some natural language text might generate grammar rules for the code generation, or an abstract syntax tree (AST) for the code generation. Such prior approaches often generate code that is syntactically incorrect such that the code does not compile or code that is otherwise reliable. Thus, it is further recognized herein that source code generation from natural text poses various technical challenges. For example, example, machine learning approaches to generating source code can result in code that does not comply with specific grammar rules corresponding to the domain language in which the source code is generated. Further, natural text is often written in an imprecise manner that can make it difficult for a computing system to interpret. Further still, a given intent can often be expressed in many different ways in natural text.

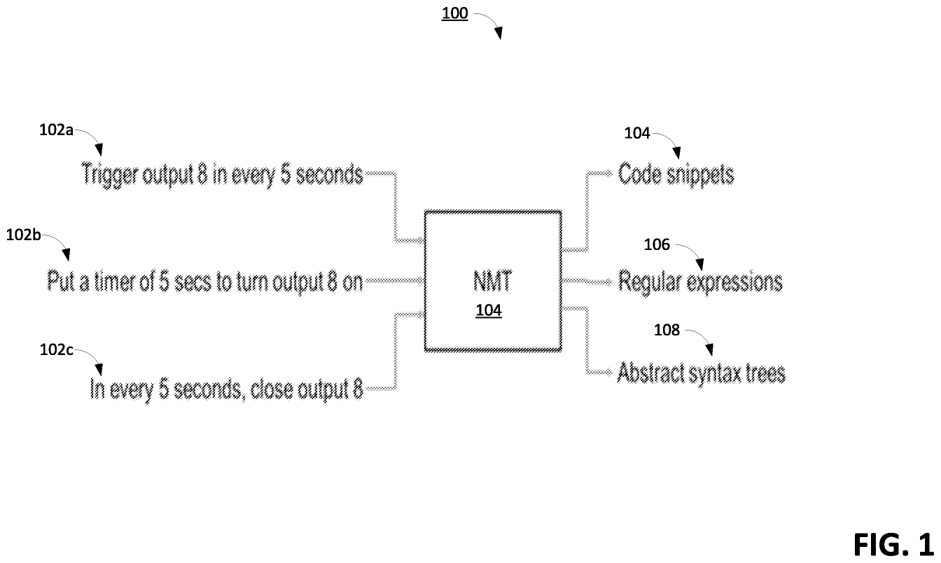

To illustrate a technical challenge by way of example, referring to FIG. 1, an example system 100 includes a first statement 102a, a second statement 102b, and a third statement 102c that are processed by a neural machine translator (NMT) module 104. Each of the statements 102a-c that appear differently in terms of natural language syntax can define the same intent in the context of programmable logic controller (PLC) source code. In particular, for example, the statements 102a-c each specify that a programmer or operator would like to insert a timer construct that triggers every five (5) seconds and energizes the output eight (8). In accordance with various example embodiments, based on the natural language statements 102a-c having different syntaxes, the NMT 104 can generate code snippets 106 as well as regular expressions 108 or abstract syntax trees 110.

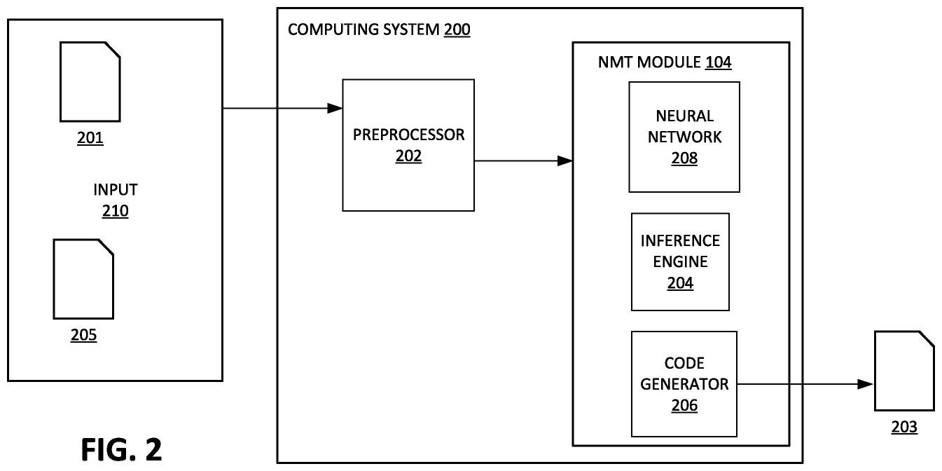

Referring now to FIG. 2, an example framework or computing system 200 includes the NMT 104 configured to automatically generate source code in various domain-specific languages (DSLs), from inputs that include natural language text. The computing system 200 can include one or more processors and memory having stored thereon applications, agents, and computer program modules including, for example, a preprocessor 202 and the NMT module 104. Similarly, the NMT module 104 can include one or more processors and memory having stored thereon applications, agents, and computer program modules including, for example, that can define an inference engine 204, a code generator module 206, and one or more neural networks, for instance a neural network or model 208.

It will be appreciated that the program modules, applications, computer-executable instructions, code, or the like depicted in FIG. 2 are merely illustrative and not exhaustive, and that processing described as being supported by any particular module may alternatively be distributed across multiple modules or performed by a different module. In addition, various program module(s), script(s), plug-in(s), Application Programming Interface(s) (API(s)), or any other suitable computer-executable code may be provided to support functionality provided by the program modules, applications, or computer-executable code depicted in FIG. 2 and/or additional or alternate functionality. Further, functionality may be modularized differently such that processing described as being supported collectively by the collection of program modules depicted in FIG. 2 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 2 may be implemented, at least partially, in hardware and/or firmware across any number of devices.

With continuing reference to FIG. 2, the computing system 200, in particular the NMT module 104, can be configured to synthesize source code 203 from an input or data 210 represented by natural language text. The source code 203 can be generated in various domain specific languages (DSLs). In some cases, for example, the computing system 200 can be customized for a specific domain such that the computing system 200 can identify domain-specific vocabulary for generating error-free source code 203 in the target language. As described herein, the system 200 can perform sequence-to-sequence translation by performing a multi-class classification and a code generation from existing templates given operators and parameters.

The NMT module 104, in particular the neural network 208, can be trained for a particular domain, for instance a particular robotics domain, on the data 210 that is processed by the preprocessor 202 so as to generate training data. During training for each domain, the input 210 to the computing system 200 can include natural language text data 201 that defines real-world data. In some cases, such real-world training data can be received or derived from multiple sources. For example, an annotator can produce training data sets by identifying/writing natural language descriptions that correspond to existing code. Additionally, or alternatively, an automated system can identify descriptions of changes to existing code that result in changes to corresponding code. By way of example, the natural language text data 201 can include instructions written in plain English or the like, such as the example statements 102a-c. The preprocessor 202 can prepare training data for the neural network 208 from the natural language text data 201 by performing data cleaning, such as by removing duplicates. In particular, for example, the output of the preprocessor 202 can indicate one or more operations associated with each statement in the natural language text data 201. Thus, the preprocessor 202 can provide training data to the neural network 208 in the form of a plurality of instances of a (E, O) tuple in which E represents a sentence or phrase (statement) written in plain English or the like, and O represents the corresponding operation invoked by the statement, which can define a parameter for input into the neural network 208. The neural network 208 can be trained for each domain, such that the operations that can be identified by the preprocessor 210 from a set of operations associated with the given domain-specific language (DSL). In some cases, the given DSL is associated with a limited number or operations, such that the preprocessor 210 can identify an operation from the limited number of operations. In an example, a given statement included in the natural language text data may indicate more than one operation. Thus, the preprocessor 210 can identify more than one operation associated with a particular statement. By way of example, “Energize output x when input y is on” is a statement that includes two operations in a PLC program. Specifically, the statement indicates an XIC (Examine if Closed) operation and an OTE (Output Energize) operation.

It is recognized herein that training the neural network 208 can require a sufficient quantity of training data of sufficient quality so that the neural network 208 is trained for each possible operation. It is further recognized herein that availability of such data can be problematic. In particular, for example, available test data or field data might be imbalanced, which can be an issue for machine learning. With respect to imbalanced data, by way of example, text corresponding to a first operation might occur more frequently as compared to text that corresponds to a second operations, such that a given neural network is not sufficiently trained on the second operation. To address such data issues, the preprocessor 210 can also be configured to generate synthetic data from the natural language text data 201. In some cases, the generated synthetic data balances the training data, such that the neural network 208 receives about an equal number of samples of data for each operation during training. The preprocessor can also perform oversampling to balanced under-represented classes (operations) of samples with other classes (operations) of samples. The preprocessor 210 can perform various natural language processing (NLP) techniques such as, stop word removal, lemmatization, vectorization, and the like so as to generate the training data from the natural language text data. Further, to generate synthetic data that represents real-world data, the preprocessor 210 can generate training data from the natural language text data 201. For example, the preprocessor 210 can replace words in the natural language text data 201 with synonyms or words that are spelled differently as compared to the text data 201 (misspelled or spelled correctly). In some cases, the preprocessor 202 can obtain synonyms from one or more libraries or language models. Additionally, or alternatively, the preprocessor 202 can shuffle or rearrange words, for instance add or delete words, in statements from the natural language test data 201 so as to generate additional training data.

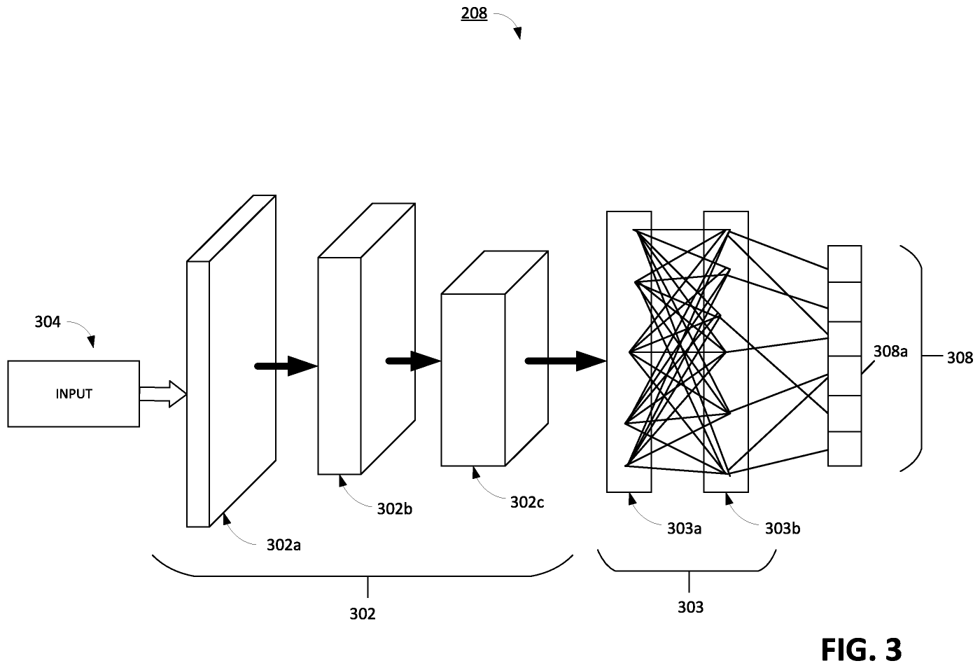

Referring also to FIG. 3, during training, the neural network 208 can receive the training data from the preprocessor 210 as input 304. In some examples, the preprocessor 210 can provide the input 304 in the form of vectors, for example, after performing vectorization so as to convert statement or strings into a corresponding numerical representation. The input 304, in particular the training data, can include natural text (e.g., a statement/phrase or sentence), one or more operations that correspond to the text, and one or more parameters that correspond to the respective operation. For example, the example first statement 102a (trigger output 8 every 5 seconds) can define natural language text data 201 that is processed and input to the neural network 208 as training data, wherein the corresponding operation is timer with two parameters (timing=5 sec and output=8). The neural network 208 which, in some cases, can define a recursive neural network, can be trained using the processed vectors as inputs 304. The operations that correspond to each input can define an output 308 of the neural network 208 during training. Thus, in various examples, the neural network 208 can be trained for a multi-class classification problem in which the output 308 during operation includes a plurality of classes that correspond to the number of operations defined by the respective DSL. In particular, during operation, the output 308 can indicate probabilities associated with various operations being present in a given natural language text data input 304. It is recognized herein that because a DSL typically defines a limited number of operations, the number of classes in the output 308 will likewise be limited. Once the neural network 208 is trained for a given domain language, for instance for a particular domain related to robotics, the model or neural network is saved for querying, as further described herein.

Still referring to FIG. 3, the example neural network 208 includes a plurality of layers, for instance an input layer 302a configured to receive natural language text data, an output layer 303b configured to generate class or output scores (e.g., probabilities) associated with natural language text data. The neural network 208 further includes a plurality of intermediate layers connected between the input layer 302a and the output layer 303b. In particular, in some cases, the intermediate layers and the input layer 302a can define a plurality of convolutional layers 302. The intermediate layers can further include one or more fully connected layers 303. The convolutional layers 302 can include the input layer 302a configured to receive training and test data. The convolutional layers 202 can further include a final convolutional or last feature layer 302c, and one or more intermediate or second convolutional layers 302b disposed between the input layer 302a and the final convolutional layer 302c. It will be understood that the illustrated network 208 is simplified for purposes of example. In particular, for example, models may include any number of layers as desired, in particular any number of intermediate layers, and all such models are contemplated as being within the scope of this disclosure.

The fully connected layers 303, which can include a first layer 303a and a second or output layer 303b, include connections between layers that are fully connected. For example, a neuron in the first layer 303a may communicate its output to every neuron in the second layer 303b, such that each neuron in the second layer 303b will receive input from every neuron in the first layer 303a. It will again be understood that the model is simplified for purposes of explanation, and that the model 208 is not limited to the number of illustrated fully connected layers 303. In contrast to the fully connected layers, the convolutional layers 302 may be locally connected, such that, for example, the neurons in the intermediate layer 302b might be connected to a limited number of neurons in the final convolutional layer 302c. The convolutional layers 302 can also be configured to share connections strengths associated with the strength of each neuron.

Still referring to FIG. 3, the output layer 303b can be configured to generate scores 208 associated with the input 304, in particular associated with a given natural language statement, thereby generating scores associated with operations. The scores in the output 308 can include a target score 308a associated with the operation intended in the natural language statement.

Referring again to FIG. 2, during operation, a user of the system 200 can provide an input query or text 205 in natural language text to the system 200. By way of an example, the input query 205 might recite “persist actuate B1.1 whenever B1.0 is open,” or the like. Thus, the input 210 can include the natural language text query 205 that can be received by the preprocessor 202 and the inference engine 204. The preprocessor 202 can perform natural language processing (NLP) on the natural language text query 205, so as to convert the natural language text query 205 into a vector. The vector can be given to the trained neural network 208 so as to define the input 304. The trained neural network 208 can then predict the operation associated with the natural language text query 205. The prediction can be indicated in the output 308.

In particular, for example, the natural text in the query 205 can first go through the preprocessor 202 and then to the NMT module 104 where the output 203 is generated. In this case, the NMT module 104 can be in a trained mode that uses the inference engine 204. The inference engine 204 can perform Named Entity Recognition (NER) and Part of Speech (POS) analysis as determine the appropriate parameters against each operation from the given text natural language text query 205. By performing NER, the inference engine 204 can determine the type of each word used in the input text 205. Further, by performing POS analysis, the inference engine can determine the dependency between different parts of the text 205. By way of example, and without limitation, dependencies among verbs, proverbs, nouns, and the like can be determined. In particular, for example a given action (verb) can be correlated or applied to a person (noun), such that the dependency can be detected between an operator and operands (parameters).

The natural language text query 205, which can also be referred to as an input sentence or statement, may indicate one or more operations that each have corresponding parameters. When the operations indicated by the natural language text query 205 are identified by the neural network 208, their corresponding parameters and the relationship among the operations can be identified by the inference engine 204. For example, the inference engine 204 can use the output 308 (operations) from the neural network 208 as input to determine dependencies. In particular, for example, the inference engine 204 can perform POS analysis to identify the dependencies among the input text tokens (or natural language text input 205), as to identify parameters for each operation. Additionally, the inference engine 204 can perform NLP so as to infer or determine whether two or more operations have a relationship with one another, and if they do have relationship, in some cases, the inference engine 204 can determine the nature of the relationship.

With continuing reference to FIG. 2, in various examples, after the operations and their associated parameters are identified, the code generator module 206 can generate DSL specific code 203. For example, the code generator module 206 can access a set of templates, for instance from a memory of the computing system 200, that are specific to each operation of the target DSL. The templates can define code snippets in the appropriate syntax associated with the given DSL. In some examples, after receiving operations and the respective parameters associated with the operations, the code generator module 206 instantiates the corresponding template. In various examples, the template that is selected and instantiated depends on the identified operation. The code generator module 206 can populate the instantiated template with the required configuration, which can include the identified operation and corresponding parameters. Thus, after populating the template, the code generator module can generate the output of the system 200 as the fully functional source code 203 that is based on the input natural text 205.

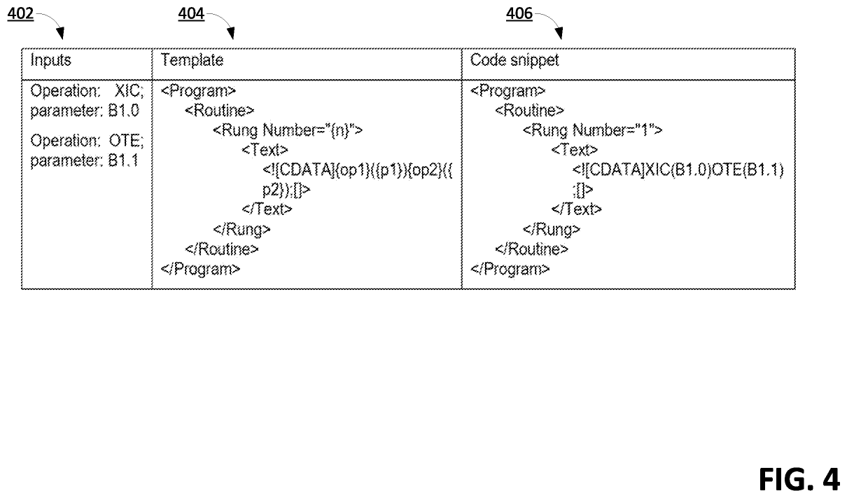

By way of example, referring to FIG. 4, a Ladder logic program can be represented as an XML file. The code generation module 204 can obtain a set of templates, for instance a template 404, to generate the source code 203 for each operation. In particular, based on example input operations and parameters 402, the code generation module 204 can retrieve the template 404, and populate the template 404 so as to generate a source code snippet 406 for a set of operation. The example shown in FIG. 4 depicts code 406 that can be generated by the code generation module 204 for a rung of a Ladder logic program from the code template 404 corresponding to the input operations 402.

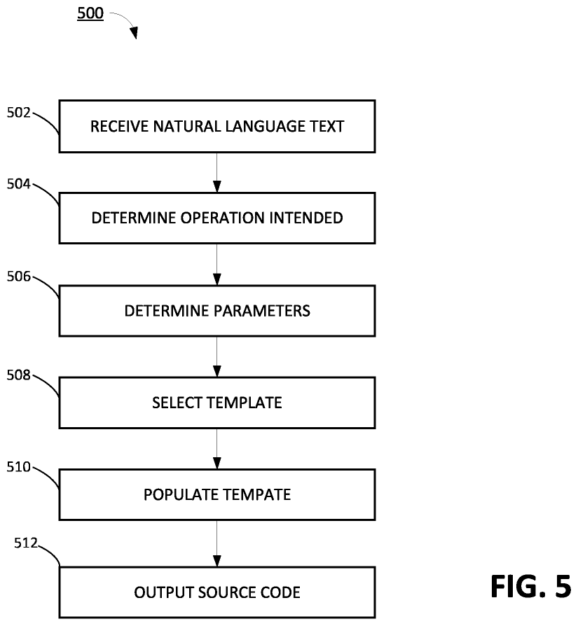

Referring now to FIG. 5, example operations 500 can be performed by a computing system that includes a neural network, for instance the computing system 200 that includes the neural network 208. For example, at 502, the neural network 208 can receive a statement written in natural language text. At 504, the neural network 208 can determine an operation intended by the statement. Based on the operation, at 506, the computing system 200, for instance the inference engine 204, can determine one or more parameters that correspond to the operation. At 508, based on the operation, the computing system 200, in particular the code generator 206, can identify or select a template in a target domain-specific language. At 510, the computing system 200, for instance the code generator module 206, can populate the template with the operation and the one or more parameters, so as to automatically generate or output source code in the target domain-specific language (at 512), from the statement written in natural language text.

In various examples, the target domain-specific language defines a set of operations, and the operation determined by the neural network is one of the operations in the set of operations. For example, a neural network can be trained for each domain-specific language. Further, the neural network can determine respective probabilities associated with a plurality of classes, so as to determine the operation. In particular, each class in the plurality of classes can correspond to a respective operation in the set of operations.

In some cases, neural networks, for instance the neural network 208, can be trained on training data associated with the target domain-specific language. The training data can include real-world text statements written in natural language. The computing system 200, for instance the preprocessor 202, can generate synthetic data from the real-world text statements written in natural language. The synthetic data can define new text statements written in natural language. For example, generating the synthetic data can include replacing one or more words of the real-world text statements with one or more synonyms of the one or more words, so as to define the new text statements written in natural language that include the one or more synonyms. Additionally, or alternatively, generating the synthetic data can include rearranging an original order of one or more words of the real-world text statements, so as to define the new text statements written in natural language that include words in a different order as compared to the original order. The training data can further include the synthetic data such that the neural network is also trained on the synthetic data.

Without being bound by theory, it is recognized herein that embodiments described herein can be characterized as separating the code generation from the natural text predictions. For example, the representative operations and corresponding parameters can first be determined, and then the source code can be generated based on the identified operations. The neural network as described herein can address the technical challenges associated with natural text ambiguities. In particular, as described herein, the neural network 208 can include an embedding layer that, in combination with training data described herein, can ensure that the system can identify intended operations, even if, for example, the real-world training data does not a include specific term for a given operation (i.e., uses alternative terms).

Again, without being bound by theory, by bifurcating the code generation that defines a template-based approach from the analysis of the natural text, better performance and efficiency can result as compared to generating source code directly from a machine learning model. In accordance with various embodiments described herein, the machine learning model (e.g., NMT module 104) is focused on solving a multi-class classification problem.

It is further recognized herein that source code can be generated in accordance with the described embodiments for various applications. By way of example, users of a TIA portal application that is used to program PLCs can have source code automatically generated (e.g., in ladder logic or STL) in accordance with embodiments described herein, by specifying their intent in natural language text. It is further recognized herein that embodiments described herein can be used by PLC programmers or people who are not inclined toward programming, as they can specify their intent and generate source code similar to their programmer peers.

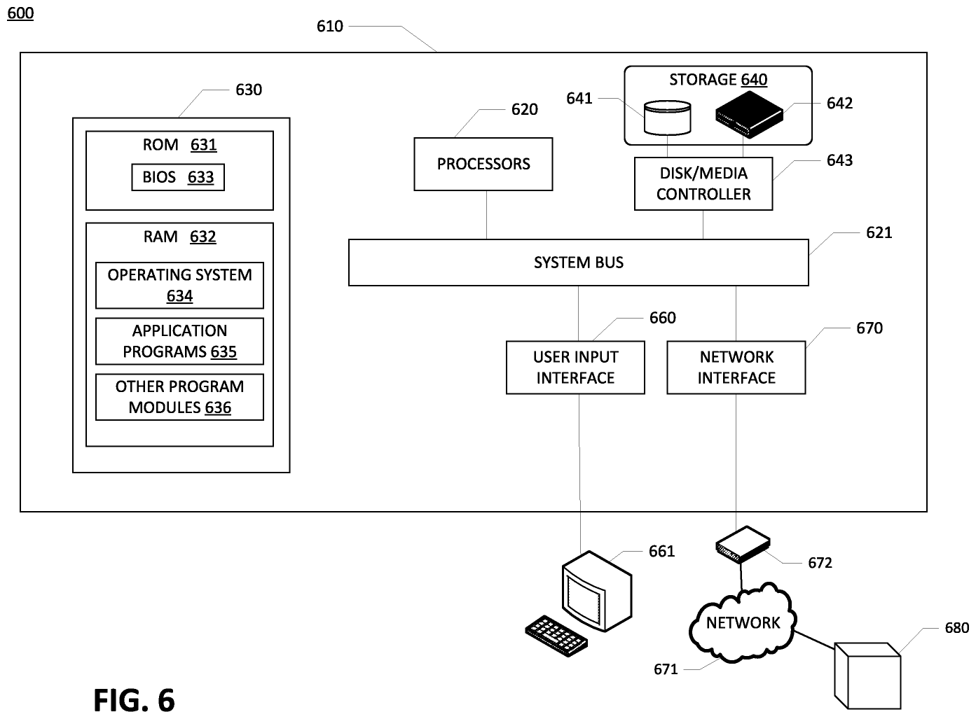

FIG. 6 illustrates an example of a computing environment within which embodiments of the present disclosure may be implemented. A computing environment 600 includes a computer system 610 that may include a communication mechanism such as a system bus 621 or other communication mechanism for communicating information within the computer system 610. The computer system 610 further includes one or more processors 620 coupled with the system bus 621 for processing the information. The computing system 202 and/or NMT module 104 the may include, or be coupled to, the one or more processors 620.

The processors 620 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 620 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 621 may include at least one of a system bus, a memory bus, an address bus, or a message bus, and may permit exchange of information (e.g., data (including computer-executable code), signaling, etc.) between various components of the computer system 610. The system bus 621 may include, without limitation, a memory bus or a memory controller, a peripheral bus, an accelerated graphics port, and so forth. The system bus 621 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 6, the computer system 610 may also include a system memory 630 coupled to the system bus 621 for storing information and instructions to be executed by processors 620. The system memory 630 may include computer readable storage media in the form of volatile and/or nonvolatile memory, such as read only memory (ROM) 631 and/or random access memory (RAM) 632. The RAM 632 may include other dynamic storage device(s) (e.g., dynamic RAM, static RAM, and synchronous DRAM). The ROM 631 may include other static storage device(s) (e.g., programmable ROM, erasable PROM, and electrically erasable PROM). In addition, the system memory 630 may be used for storing temporary variables or other intermediate information during the execution of instructions by the processors 620. A basic input/output system 633 (BIOS) containing the basic routines that help to transfer information between elements within computer system 610, such as during start-up, may be stored in the ROM 631. RAM 632 may contain data and/or program modules that are immediately accessible to and/or presently being operated on by the processors 620. System memory 630 may additionally include, for example, operating system 634, application programs 635, and other program modules 636. Application programs 635 may also include a user portal for development of the application program, allowing input parameters to be entered and modified as necessary.

The operating system 634 may be loaded into the memory 630 and may provide an interface between other application software executing on the computer system 610 and hardware resources of the computer system 610. More specifically, the operating system 634 may include a set of computer-executable instructions for managing hardware resources of the computer system 610 and for providing common services to other application programs (e.g., managing memory allocation among various application programs). In certain example embodiments, the operating system 634 may control execution of one or more of the program modules depicted as being stored in the data storage 640. The operating system 634 may include any operating system now known or which may be developed in the future including, but not limited to, any server operating system, any mainframe operating system, or any other proprietary or non-proprietary operating system.

The computer system 610 may also include a disk/media controller 643 coupled to the system bus 621 to control one or more storage devices for storing information and instructions, such as a magnetic hard disk 641 and/or a removable media drive 642 (e.g., floppy disk drive, compact disc drive, tape drive, flash drive, and/or solid state drive). Storage devices 640 may be added to the computer system 610 using an appropriate device interface (e.g., a small computer system interface (SCSI), integrated device electronics (IDE), Universal Serial Bus (USB), or FireWire). Storage devices 641, 642 may be external to the computer system 610.

The computer system 610 may also include a field device interface 665 coupled to the system bus 621 to control a field device 666, such as a device used in a production line. The computer system 610 may include a user input interface or GUI 661, which may comprise one or more input devices, such as a keyboard, touchscreen, tablet and/or a pointing device, for interacting with a computer user and providing information to the processors 620.

The computer system 610 may perform a portion or all of the processing steps of embodiments of the invention in response to the processors 620 executing one or more sequences of one or more instructions contained in a memory, such as the system memory 630. Such instructions may be read into the system memory 630 from another computer readable medium of storage 640, such as the magnetic hard disk 641 or the removable media drive 642. The magnetic hard disk 641 (or solid state drive) and/or removable media drive 642 may contain one or more data stores and data files used by embodiments of the present disclosure. The data store 640 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 620 may also be employed in a multi-processing arrangement to execute the one or more sequences of instructions contained in system memory 630. In alternative embodiments, hard-wired circuitry may be used in place of or in combination with software instructions. Thus, embodiments are not limited to any specific combination of hardware circuitry and software.

As stated above, the computer system 610 may include at least one computer readable medium or memory for holding instructions programmed according to embodiments of the invention and for containing data structures, tables, records, or other data described herein. The term “computer readable medium” as used herein refers to any medium that participates in providing instructions to the processors 620 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 641 or removable media drive 642. Non-limiting examples of volatile media include dynamic memory, such as system memory 630. Non-limiting examples of transmission media include coaxial cables, copper wire, and fiber optics, including the wires that make up the system bus 621. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 600 may further include the computer system 610 operating in a networked environment using logical connections to one or more remote computers, such as remote computing device 680. The network interface 670 may enable communication, for example, with other remote devices 680 or systems and/or the storage devices 641, 642 via the network 671. Remote computing device 680 may be a personal computer (laptop or desktop), a mobile device, a server, a router, a network PC, a peer device or other common network node, and typically includes many or all of the elements described above relative to computer system 610. When used in a networking environment, computer system 610 may include modem 672 for establishing communications over a network 671, such as the Internet. Modem 672 may be connected to system bus 621 via user network interface 670, or via another appropriate mechanism.

Network 671 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., remote computing device 680). The network 671 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 671.

It should be appreciated that the program modules, applications, computer-executable instructions, code, or the like depicted in FIG. 6 as being stored in the system memory 630 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 610, the remote device 680, and/or hosted on other computing device(s) accessible via one or more of the network(s) 671, may be provided to support functionality provided by the program modules, applications, or computer-executable code depicted in FIG. 6 and/or additional or alternate functionality. Further, functionality may be modularized differently such that processing described as being supported collectively by the collection of program modules depicted in FIG. 6 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 6 may be implemented, at least partially, in hardware and/or firmware across any number of devices.

It should further be appreciated that the computer system 610 may include alternate and/or additional hardware, software, or firmware components beyond those described or depicted without departing from the scope of the disclosure. More particularly, it should be appreciated that software, firmware, or hardware components depicted as forming part of the computer system 610 are merely illustrative and that some components may not be present or additional components may be provided in various embodiments. While various illustrative program modules have been depicted and described as software modules stored in system memory 630, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method of generating source code in a target domain-specific language, the method comprising:
receiving a statement written in natural language text;
determining, by a neural network, an operation intended by the statement;
based on the operation, determining one or more parameters that correspond to the operation;
based on the operation, identifying a template in the target domain-specific language; and
populating the template with the operation and the one or more parameters, so as to generate the source code in the target domain-specific language.

2. The computer-implemented method as recited claim 1, wherein the target domain-specific language defines a set of operations, and the operation determined by the neural network is one of the operations in the set of operations.

3. The computer-implemented method as recited in claim 2, wherein determining the operation intended by the statement further comprises:
determining, by the neural network, respective probabilities associated with a plurality of classes, each class in the plurality of classes corresponding to a respective operation in the set of operations.

4. The computer-implemented method as recited in claim 1, the method further comprising:
training the neural network on training data associated with the target domain-specific language, the training data comprising real-world text statements written in natural language.

5. The computer-implemented method as recited in claim 4, the method further comprising:
generating synthetic data from the real-world text statements written in natural language, the synthetic data defining new text statements written in natural language.

6. The computer-implemented method as recited in claim 5, wherein generating the synthetic data further comprises replacing one or more words of the real-world text statements with one or more synonyms of the one or more words, so as to define the new text statements written in natural language that include the one or more synonyms.

7. The computer-implemented method as recited in claim 5, wherein generating the synthetic data further comprises rearranging an original order of one or more words of the real-world text statements, so as to define the new text statements written in natural language that include words in a different order as compared to the original order.

8. The computer-implemented method as recited in claim 5, wherein the training data further comprises the synthetic data such that the neural network is also trained on the synthetic data.

9. A computing system configured to generate source code in a plurality of domain-specific languages, the computing system comprising:
one or more processors; and
a memory storing instructions that, when executed by the one or more processors, cause the computing system to:
receive a statement written in natural language text;
determine an operation intended by the statement;
based on the operation, determine one or more parameters that correspond to the operation;
based on the operation, identify a template in a target domain-specific language of the plurality of domain-specific languages; and
populate the template with the operation and the one or more parameters, so as to generate the source code in the target domain-specific language.

10. The computing system as recited in claim 9, wherein the target domain-specific language defines a set of operations, and the operation determined by the computing system is one of the operations in the set of operations.

11. The computing system as recited in claim 10, the memory further storing instructions that, when executed by the one or more processors, further cause the computing system to:
determine respective probabilities associated with a plurality of classes, each class in the plurality of classes corresponding to a respective operation in the set of operations.

12. The computing system as recited in claim 9, the memory further storing instructions that, when executed by the one or more processors, further cause the computing system to:
train a neural network on training data associated with the target domain-specific language, the training data comprising real-world text statements written in natural language.

13. The computing system as recited in claim 12, the memory further storing instructions that, when executed by the one or more processors, further cause the computing system to:
generate synthetic data from the real-world text statements written in natural language, the synthetic data defining new text statements written in natural language.

14. The computing system as recited in claim 13, the memory further storing instructions that, when executed by the one or more processors, further cause the computing system to:
replace one or more words of the real-world text statements with one or more synonyms of the one or more words, so as to define the new text statements written in natural language that include the one or more synonyms.

15. The computing system as recited in claim 13, the memory further storing instructions that, when executed by the one or more processors, further cause the computing system to:
rearrange an original order of one or more words of the real-world text statements, so as to define the new text statements written in natural language that include words in a different order as compared to the original order.

16. The computing system as recited in claim 13, wherein the training data further comprises the synthetic data such that the neural network is also trained on the synthetic data.

17. A non-transitory computer-readable storage medium including instructions that, when processed by a computing system, configure the computing system to perform the method according to claim 1.
